(19) United States
(12) Patent Application Publication
(10) Pub. No.: US 2024/0319115 A1
(43) Pub. Date: Sep. 26, 2024

(54) METHOD FOR GENERATING A MAP REPRESENTING MECHANICALLY ALTERED AREAS OF AN ADHESIVE WITHIN A BONDED ASSEMBLY OF COMPOSITE MATERIALS, CORRESPONDING DEVICE AND COMPUTER PROGRAM

(71) Applicants: UNIVERSITE TOULOUSE III - PAUL SABATIER, Toulouse (FR); COMPOSITE EXPERTISE ET SOLUTIONS, La-Penne-Sur-Huveaune (FR); CENTRE NATIONAL DE LA RECHERCHE SCIENTIFIQUE, Paris - Cedex 16 (FR)

(72) Inventors: Francis COLLOMBET, Toulouse (FR); Yves-Henri GRUNEWALD, La-Penne-Sur-Huveaune (FR)

(21) Appl. No.: 18/577,705

(22) PCT Filed: Jul. 8, 2022
(86) PCT No.: PCT/EP2022/069184

§ 371 Date: Jan. 9, 2024

(30) Foreign Application Priority Data
Jul. 9, 2021 (FR) FR2107480

(51) Int. Cl. G01N 23/04; B32B 7/12; C09J 9/00; C09J 11/04; G01N 23/083; G01N 23/18

(52) U.S. Cl. CPC G01N 23/04; B32B 7/12; C09J 9/00; C09J 11/04; G01N 23/083; G01N 23/18; B32B 2264/105; B32B 2307/208; G01N 2223/615

(57) ABSTRACT

Method for generating a map representing mechanically altered zones of an adhesive in a glued assembly of composite materials, corresponding device and computer program.

The invention relates to a method for determining the state of the mechanical properties of a glued assembly of materials by applying a local thermal source exciting particles included in the adhesive and studying the consequences of this excitation on the mechanical properties of the adhesive by high-frequency electromagnetic imaging.

### FIELD OF THE INVENTION

The field of the invention is that of composite materials. More precisely, the invention relates to a solution for detecting mechanical defects in a glued assembly of composite materials produced by means of an adhesive.

### Prior Art and Drawbacks Thereof

There are many techniques for testing the strength of a multimaterial glued assembly. By glued assembly it is meant an assembly consisting of an adhesive, or glue joint, placed between a first substrate and a second substrate, at least one of said substrates consisting of a composite material.

Such techniques make it possible to detect the presence of visible defects, such as gluing defects, or of ageing of the glued assembly of composite materials.

However, such techniques do not make it possible to determine the presence of defects that cause mechanical weakness in the glue joint or detachment of the glue joint/substrate interface of the “kiss bonding” type. However, defects of this type are one of the reasons that prevent greater use of gluing of composite materials, in particular in the aeronautical industry, since methods are lacking for detecting defects locally causing mechanical weakness of the adhesive of a glued assembly of composite materials.

The document “NDT-based design of joint material for the detection of bonding defects by infrared thermography”, M. Barus et al., NDT and E International 93 (2018) 157-163, proposes a non-destructive method for detecting mechanical weaknesses of an assembly consisting of an adhesive placed between a first substrate and a second substrate, at least one of said substrates consisting of a composite material. Such a method is based on the introduction of additives having a particular infrared signature in the adhesive in order to make it visible to infrared radiation.

One drawback of the method described in this document is that it does not make it possible to detect defects such as mechanical weakening of the glued assembly. This stems in particular from the composite nature of the substrates used. This is because the substrates produced from composite materials based on carbon fibre make it difficult, through their nature, to collect information relating to a deformation field in the adhesive following a local rise in temperature caused by a source of infrared radiation, and this despite the introduction of additives, in a high percentage, into the adhesive (because of the similar thermal characteristics between the resin of the substrate and that of the adhesive).

There is therefore a need for a non-destructive technique for detecting in situ mechanical weaknesses of an assembly consisting of an adhesive placed between a first substrate and a second substrate, at least one of said substrates consisting of a composite material, does not have all or some of the aforementioned drawbacks.

### DESCRIPTION OF THE INVENTION

The invention meets this need by proposing a method for generating a map representing mechanically altered zones of a so-called glued assembly consisting of an adhesive comprising particles visible by high-frequency electromagnetic imaging, said adhesive being placed between a first substrate and a second substrate, at least one of said substrates consisting of a composite material, said method comprising the following steps:
obtaining, by high-frequency electromagnetic imaging, first positions of said particles in the glued assembly,
local thermal excitation of said glued assembly,
obtaining, by high-frequency electromagnetic imaging, second positions of said particles in the glued assembly,
generating said map representing mechanically altered zones by associating, with at least one zone of the glued assembly, a value of at least one parameter representing a mechanical alteration of the adhesive, said value of said at least one parameter representing a mechanical alteration of the adhesive and said corresponding glued assembly zone being determined according to said first positions and said second positions of said particles and reference values.

Such a solution makes it possible to determine, in situ, the state of the mechanical properties of the adhesive joint of a glued assembly. This is because such a solution makes it possible to take a reading of the zones of an adhesive joint of a glued assembly the mechanical properties of which may be altered, though such alterations are not visible and/or detectable by known nondestructive techniques.

The use of high-frequency electromagnetic radiation, such as X-rays, makes it possible to be free from the absorption constraints related to substrates produced from carbon fibres. Precise and clear images of the particles present in the adhesive are obtained. Such images allow reliable and precise measurement of the positions of the particles.

It is then possible, from the map representing mechanically altered zones of a glued assembly, to proceed with targeted repairs of the glued assembly. It is also possible to use this method in the context of regular maintenance operations performed for example on a fuselage or on any accessible zones of a composite structure benefiting from glued assembly.

In a first implementation of the method that is the object of the invention, at least one parameter representing a mechanical alteration of a glued assembly is a value of the Young's modulus of the adhesive.

When, for a given zone of the glued assembly, the value of the Young's modulus of the adhesive measured after the excitation of the particles is lower than the reference value of the Young's modulus of the adhesive, it is deduced from this that the mechanical properties of the glued assembly in this zone have been altered. This then appears on the map representing mechanically altered zones.

In order to facilitate the determination of the positions of the particles, in a particular example embodiment of the method that is the object of the invention, the glued assembly comprises a reference grid forming a fixed reference frame for measuring a movement of the excitable particles in the adhesive.

Such a grid deforms very little under stress, which makes it possible to use it as a reference frame for measuring movements of the particles in the adhesive. The measurements of the movements of the particles are also made more precise by the use of such a reference grid.

In one example embodiment, the method comprises a preliminary step of determining the reference value of the movement of a particle during thermal excitation. The generation step thus comprises a substep of determining the actual value of movement of said particles after thermal excitation from the first and second positions, said value of said at least one parameter representing a mechanical alteration being determined from the comparison between said reference values and said actual values of movement of the particles.

The actual movement of the particles can be determined from the movement of each particle between its first and second positions so as to be compared with the reference value. Using such a reference value thus makes it possible to easily detect a variation in the mechanical properties from a difference between the actual value of the movement and the reference value.

In a first example embodiment of the method for generating a map representing mechanically altered zones of a glued assembly that is the object of the invention, the adhesive comprising magnetic particles, the glued assembly is thermally excited by the heat generated by the local application of a magnetic field to the magnetic particles.

In this first example embodiment of the invention, the method takes advantage of the use of a local magnetic field for exciting magnetic particles capable of generating heat flows, in a very short period of time and locally. This is because, depending on the material selected for forming the magnetic core of the electromagnet used, it is possible to act on the speed of the magnetic field to excite the particles as well as on the location of this excitation in the glued assembly.

Preferably, the magnetic particles are the particles visible by high-frequency electromagnetic imaging.

Thus the particles fulfil the dual function of the generation of heat and visibility of the high-frequency electromagnetic imaging.

In a second example embodiment of the method for generating a map representing mechanically altered zones of a glued assembly that is the object of the invention, the glued assembly is thermally excited by an external source of heat.

In this second example embodiment, a source of heat external to the adhesive is used, such as a heating finger, which can be moved over a surface of the glued assembly.

The invention also relates to a glued assembly consisting of an adhesive placed between a first substrate and a second substrate, at least one of said substrates consisting of a composite material, in such a glued assembly, the adhesive comprises particles visible by high-frequency electromagnetic imaging making it possible to determine a value of at least one parameter representing a mechanical alteration of the adhesive when the glued assembly has been thermally excited.

Through the particular constitution of this glued assembly, it is possible to determine, in situ, the state of mechanical properties of the adhesive. This is because it becomes possible to take a reading of zones of an adhesive joint of this glued assembly the mechanical properties of which can be altered by irradiating the glued assembly with high-frequency electromagnetic radiation, such as X-rays.

Precise and clear images of the particles present in the adhesive are obtained. Such images allow reliable and precise measurement of the positions of the particles.

Depending on the nature of the particles used, the techniques used for causing local deformation of the adhesive may vary.

Thus, when the particles introduced into the adhesive have magnetic properties, a local magnetic field is applied to the glued assembly in order to excite the particles, which then generate a heat flow, the action of which causes a local deformation of the adhesive in a very short period of time.

When the particles introduced into the adhesive do not have magnetic properties, a heat flow is transmitted, for example locally, to the adhesive to cause deformation to the latter. Such a heat flow can be generated by means of a heating finger that is moved on the surface of the glued assembly.

It is then possible to determine the existence of a weakening of the mechanical properties in certain zones of the adhesive.

In a particular implementation of the glued assembly that is the object of the invention, it comprises a reference grid forming a fixed reference frame for measuring a movement of the particles.

Such a grid deforms very little under stress, which makes it possible to use it as a reference frame for measuring movements of the particles in the adhesive.

The reference grid can be deposited on at least one of said substrates constituting the glued assembly.

This variant embodiment cleverly uses the properties of the material constituting the substrate and in particular the fact that the latter deforms very little with respect to the adhesive. Such a reference grid is for example deposited on one of the two substrates in the form of plasma.

Advantageously, in a particular example embodiment of the glued assembly that is the object of the invention, the adhesive comprises a support comprising said particles.

Such a support is for example a marquisette, a support used by adhesive manufacturers to calibrate the thickness of adhesive, deposited between the first and the second substrate.

Advantageously, in another particular example embodiment of the glued assembly that is the object of the invention, the reference grid is the support comprising said particles, said support being embedded in the adhesive.

This makes it possible to reduce the manufacturing costs of the glued assembly.

Another object of the invention is a device for generating a map representing mechanically altered zones of a glued assembly consisting of an adhesive comprising particles visible by high-frequency electromagnetic imaging placed between a first substrate and a second substrate, at least one of said substrates consisting of a composite material, said device comprising means for:
determining, from a first image obtained by high-frequency electromagnetic imaging, first positions of said particles in the glued assembly,
determining, from a second image obtained by high-frequency electromagnetic imaging, second positions of said particles in the glued assembly following the application, to said glued assembly, of a local thermal excitation,
generating said map representing mechanically altered zones by associating, with at least one glued assembly zone, a value of at least one parameter representing a mechanical alteration of the adhesive, said value of said at least one parameter representing a mechanical alteration of the adhesive and said corresponding glued assembly zone being determined according to said first positions, said second positions of said excitable particles and reference values.

The invention further relates to a system comprising a device as described previously and a module for moving the device on the glued assembly in order to sweep the whole of the glued assembly.

The thermal stressing is implemented locally, which involves a deformation field which, at the boundary of the heated zone, is discontinuous (because of the differential deformation between the heated zone and the non-heated zone). The device detecting mechanically altered zones at this discontinuity, the movement module makes it possible to move this discontinuity over the whole of the zone to be analysed in order to generate a map of the glued assembly.

Finally, the invention relates to a computer program product comprising program code instructions for implementing a method as described previously, when it is executed by a processor.

The invention also relates to a recording medium that can be read by a computer on which a computer program is recorded comprising program code instructions for implementing steps of the method according to the invention as described above.

Firstly, such a recording medium may be any entity or device capable of storing the program. For example, the medium may include a storage means, such as a ROM, for example a CD-ROM or a microelectronic circuit ROM, or a magnetic recording means, for example a USB key or a hard disk.

Secondly, such a recording medium may be a transmissible medium such as an electrical or optical signal, which can be conveyed via an electrical or optical cable, by radio or by other means, so that the computer program that it contains is remotely executable. The program according to the invention can in particular be downloaded on a network, for example the internet.

Alternatively, the recording medium may be an integrated circuit in which the program is incorporated, the circuit being adapted to execute or be used in the execution of the method that is the object of the invention.

### LIST OF FIGURES

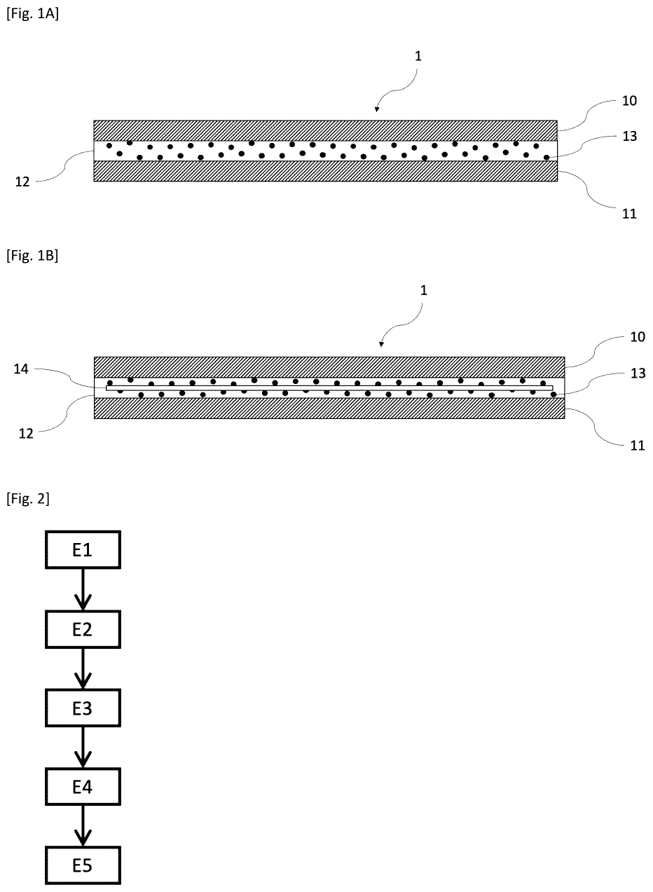

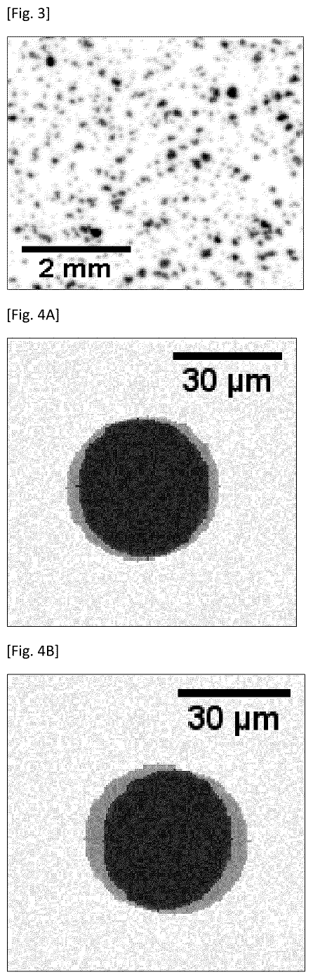

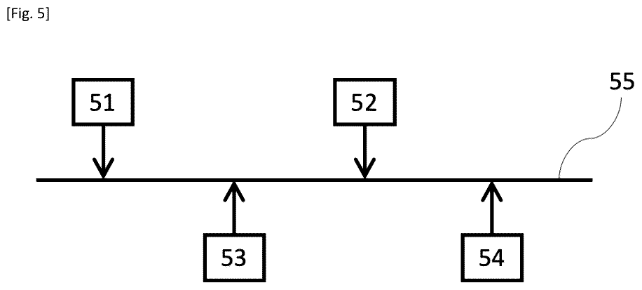

Other aims, features and advantages of the invention will emerge more clearly from the reading of the following description, given by way of simple illustrative and non-limitative example, in relation to the accompanying figures, among which:

[FIG. 1A]: this figure shows a glued assembly according to a first example embodiment of the invention,

[FIG. 1B]: this figure shows a glued assembly according to a second example embodiment of the invention,

[FIG. 2]: this figure shows the various steps of a method for generating a map representing mechanically altered zones of an adhesive according to the invention,

[FIG. 3]: this figure shows an image of the glued assembly obtained by irradiating the glued assembly by means of high-frequency electromagnetic radiation,

[FIG. 4A]: this figure shows a particle included in the adhesive.

[FIG. 4B]: this figure shows the same particle as FIG. 4A following the application of a local thermal excitation,

[FIG. 5]: this figure shows a device for generating a map representing mechanically altered zones of a glued assembly according to the invention,

### DETAILED DESCRIPTION OF EXAMPLE EMBODIMENTS OF THE INVENTION

The general principle of the invention is based on introducing particles visible by high-frequency electromagnetic imaging into an adhesive deposited between a first substrate and a second substrate, at least one of the two substrates being a composite material. These particles are the subject of an excitation (and are therefore called excitable particles). The presence of these excitable particles in the adhesive makes it possible to determine, non-destructively and in situ, the state of certain mechanical properties of the adhesive. Thus it becomes possible to check regularly, during maintenance operations, the state of certain mechanical properties of objects comprising such a glued assembly, such as for example aircraft fuselages, but also other parts comprising glued assemblies. One object of the present technique is to implement a mapping of the flows of forces passing within an adhesive disposed between two substrates. These two substrates can for example be made from composite materials comprising for example a matrix (thermosetting or thermoplastic) and reinforcing fibres (carbon, glass, aramid, etc.).

In accordance with the present technique, in relation to [FIG. 1A], an example of such a glued assembly 1 according to a first example embodiment of the invention is presented. Such a glued assembly 1 comprises: a first substrate 10 and a second substrate 11 glued together by means of an adhesive layer 12. At least one of the substrates 10, 11 is a substrate made from composite material, for example based on carbon fibres or glass fibres. The resin of at least one of the substrates 10, 11 is a resin made from polymer material, for example a thermosetting resin, in particular an epoxy resin, or a thermoplastic or elastomeric resin. The adhesive 12 consists of a resin similar to the resin of the substrates 10, 11. It is the use of the same type of resin for the substrates and the adhesive that makes the visibility of the glued assembly complex and for which the invention proposes a solution. Particles 13 visible by high-frequency electromagnetic imaging, such as X-ray imaging, such as for example metal particles or particles having magnetic properties, are introduced into the adhesive 12, for example during the manufacture of the epoxy resin, in variable quantities depending on the nature of the particles 13, of the substrates 10, 11 and of the adhesive 12. By way of example, stainless-steel particles of the 316L stainless steel type can be introduced into the adhesive 12.

In relation to [FIG. 1B], an example of such a glued assembly 1 according to a second example embodiment of the invention is presented. Such a glued assembly 1 comprises: a first substrate 10 and a second substrate 11 glued together by means of an adhesive layer 12. At least one of the substrates 10, 11 is a substrate made from composite material, for example based on carbon fibres. The adhesive 12 comprises a resin, for example epoxy. The adhesive 12 may furthermore comprise a support 14, such as a marquisette, making it possible to calibrate the thickness of the adhesive joint 12. This support 14 is embedded in the resin. Particles 13, are introduced into the adhesive 12, for example during the manufacture of the epoxy resin, in variable quantities depending on the nature of the particles 13, of the substrates 10, 11 and of the adhesive 12.

Introducing the particles 13 into the adhesive 12 functionalizes the adhesive 12 by making it interrogatable by the method that will be described subsequently.

According to a variant that is not shown on the figures, the particles 13 are introduced not into the resin of the adhesive 12 but into the support 14, for example when the latter is manufactured. Thus, the composition of the resin is not modified, which is advantageous in fields such as aeronautics, requiring long and expensive campaigns of certifying the materials at each modification.

The glued assembly 1 can furthermore comprise a reference grid forming a fixed reference frame for measuring a movement of the particles within the adhesive 12. The reference grid can be deposited on at least one of said substrates 10, 11 constituting the glued assembly 1. The material constituting the substrate 10, 11 being not very deformable, the dimensions and the positioning of the reference grid remain stable over time, thus ensuring reliability of the measurements made during the life of the glued assembly 1. Such a reference grid is for example deposited on one of the two substrates 10, 11 in the form of plasma.

In another example embodiment of the glued assembly 1 that is the object of the invention, the reference grid is the support 14 for the adhesive 12.

Such a glued assembly 1 is used in a method for generating a map representing mechanically altered zones of a glued assembly, the various steps of which are described with reference to [FIG. 2].

In a preliminary step, a reference value of the movement of the particles is determined. This reference value corresponds to the theoretical movement of a particle in an assembly not having any mechanical alteration following thermal excitation. Such a reference value can be determined numerically from a finite element calculation for which the input data are the mechanical characteristics of the assembly.

During a step E1, a first image of the glued assembly 1 is obtained by irradiating the glued assembly 1 by means of high-frequency electromagnetic radiation, such as for example X-radiation.

FIG. 3 shows such a first image. Each dark spot represents a particle present in the adhesive 12. This is because the particles introduced into the adhesive 12 have the property of reacting to the high-frequency electromagnetic radiation applied to the glued assembly 1 so that they appear on the first image.

From this first image, it is possible to determine, for all the particles visible on this first image, first positions in the glued assembly 1. Determining these first positions is for example facilitated by the presence, in the glued assembly 1, of the reference grid.

In a step E2, a local mechanical stressing of a thermomechanical nature is applied to the glued assembly 1. Such a local mechanical stressing takes the form of local thermal excitation applied to the glued assembly 1.

This local stressing involves a deformation field which, at the boundary of the heated zone, is discontinuous (because of the differential deformation between the heated zone and the non-heated zone). It is this discontinuity that is taken advantage of by the present invention to determine whether the boundary zone is mechanically altered.

In a first example embodiment of the invention, the glued assembly 1 is thermally excited by an external source of heat. Such an external source of heat is for example an electric element that can be in the form of a heating finger that can be moved over the entire surface of the glued assembly 1 in order to move the boundary zone that is being studied.

In a second example embodiment of the invention, particles (which may be distinct from the particles 12) having mechanical properties are introduced into the adhesive 12. In this second example embodiment, the local thermal excitation is obtained by applying an alternating magnetic field to the glued assembly 1. Applying this alternating magnetic field excites the magnetic particles, which then generate heat. For example, some magnetic particles can produce temperature variations of the order of several tens of degrees in the space of a millisecond when they are excited by an appropriate magnetic field. Just as in the first example embodiment, the source of the alternating magnetic field can be moved over the entire surface of the glued assembly 1.

The local temperature rise caused by the thermal excitation causes local mechanical stresses in the adhesive joint 12. Such mechanical stresses make it possible to reveal the existence of weakening of certain mechanical properties of the adhesive 12 in certain zones of the glued assembly 1.

In a step E3, a second image of the glued assembly 1 is obtained by irradiating the glued assembly 1 by means of high-frequency electromagnetic radiation, such as for example X-radiation.

From this second image, it is possible to determine, for all the particles visible on this second image, second positions in the glued assembly 1. Determining these second positions is for example facilitated by the presence, in the glued assembly 1, of the reference grid.

Steps E1 and E3 are implemented, for example, by a portable radiography device. The images acquired by such a device are next transmitted for example to a computer capable of implementing steps E4 and E5 described below.

FIG. 4A and [FIG. 4B] show respectively a particle in first positions and the same particle in second positions following the application of a local thermal excitation during step E2. Knowing the first positions and the second positions of the particle, an actual movement value of the particles in the adhesive 12 (movement field) representing a weakening of certain mechanical properties of the adhesive 12 in certain zones of the glued assembly 1 is deduced therefrom in a step E4. From this actual movement value of a particle and from the reference value, a value of at least one parameter representing a mechanical alteration of the glued assembly 1 is determined.

Such a parameter representing a mechanical alteration of the glued assembly 1 can in particular be a value of the deformation, obtained by deriving from the particle movement values.

To do this, the deformation values (related to the Young's modulus) of the assembly are calculated from the difference between the reference value and the actual movement value of each particle. When this difference exceeds a tolerance threshold, a mechanical alteration is detected at the particle. In other words, a difference between the actual movement value and the reference value represents an alteration of the mechanical properties of the adhesive 12.

The value of the parameter representing a mechanical alteration is then determined from the difference between these reference values and these actual values. In practice, it is the deformation fields, obtained by deriving from the movement fields, that are compared.

Step E4 is implemented for all the particles that can be identified on the first image and the second image.

In a step E5, a map representing the mechanically altered zones of the glued assembly 1 is generated, for example in the form of a colour-level map.

Such a map representing mechanically altered zones of this glued assembly 1 is for example obtained by associating, with at least one zone of the glued assembly 1, the coordinates of which in a given reference frame, for example the reference frame of the reference grid, are known, one or more values of the parameter representing a mechanical alteration of the adhesive 12 obtained during step E4, corresponding to one or more particles located in the zone of the glued assembly 1 in question.

The map representing mechanically altered zones of the glued assembly 1 thus obtained can be stored with a view to being transmitted to remote equipment for processing.

FIG. 5 shows a device for generating a map representing mechanically altered zones of a glued assembly according to the invention.

A device for generating a map representing mechanically altered zones of a glued assembly can comprise at least one hardware processor 51, a storage unit 52, a first communication interface 53 and a second communication interface 54 that are connected together through a bus 55. Naturally, the elements constituting the device for generating a map representing mechanically altered zones of a glued assembly can be connected by means of a connection other than a bus.

The processor 51 controls the operations of the device for generating a map representing mechanically altered zones of a glued assembly. The storage unit 52 stores at least one program for implementing the method according to an example embodiment to be implemented by the processor 51, and various data, such as parameters used for calculations made by the processor 51, intermediate data of calculations made by the processor 51, etc. The processor 51 can be formed by any known suitable hardware or software, or by a combination of hardware and software. For example, the processor 51 can be formed by dedicated hardware such as a processing circuit, or by a programmable processing unit such as a central processing unit that executes a program stored in a memory thereof.

The storage unit 52 can be formed by any suitable means capable of storing the program or programs and data in a manner that can be read by a computer. Examples of a storage unit 52 comprise non-transient storage media that can be read by computer such as semiconductor memory devices, and magnetic, optical or magnetooptical recording media loaded in a read and write unit.

The first communication interface 53 provides a connection between the device for generating a map representing mechanically altered zones of a glued assembly and the portable radiography device.

The second communication interface 54 provides a connection between the device for generating a map representing mechanically altered zones of a glued assembly and remote equipment to which a map representing mechanically altered zones of a glued assembly can be transmitted.

1. A method for generating a map representing mechanically altered zones of a so-called glued assembly consisting of an adhesive comprising particles visible by high-frequency electromagnetic imaging, said adhesive being placed between a first substrate and a second substrate, at least one of said substrates consisting of a composite material, said method comprising the following steps:
obtaining, by high-frequency electromagnetic imaging, first positions of said particles in the glued assembly,
local thermal excitation of said glued assembly,
obtaining, by high-frequency electromagnetic imaging, second positions of said particles in the glued assembly,
generating said map representing mechanically altered zones by associating, with at least one glued assembly zone, a value of at least one parameter representing a mechanical alteration of the adhesive, said value of said at least one parameter representing a mechanical alteration of the adhesive and said corresponding glued assembly zone being determined according to said first positions and said second positions of said particles and at least one reference value of the movement of a particle during thermal excitation.

2. The method for generating a map representing mechanically altered zones of a glued assembly according to claim 1, wherein said at least one parameter representing a mechanical alteration of a glued assembly is a value of the Young's modulus of the adhesive.

3. The method for generating a map representing mechanically altered zones of a glued assembly according to claim 1, wherein the glued assembly comprises a reference grid forming a fixed reference frame for measuring a movement of the particles within the adhesive.

4. The method for generating a map representing mechanically altered zones of a glued assembly according to claim 1, comprising a preliminary step of determining said at least one reference value of the movement of the particle during thermal excitation, and wherein the generation step comprises a substep of determining the actual value of movement of said particles after thermal excitation from the first and second positions, said value of said at least one parameter representing a mechanical alteration being determined from the comparison between said reference value and said actual value of movement of the particles.

5. The method for generating a map representing mechanically altered zones of a glued assembly according to claim 1, wherein the adhesive comprises magnetic particles and the glued assembly is thermally excited by the heat generated by the local application of a magnetic field to the magnetic particles.

6. The method according to claim 5, wherein the magnetic particles are the particles visible by high-frequency electromagnetic imaging.

7. The method for generating a map representing mechanically altered zones of a glued assembly according to claim 1, wherein the glued assembly is thermally excited by an external source of heat.

8. A glued assembly consisting of an adhesive placed between a first substrate and a second substrate, at least one of said substrates consisting of a composite material, said glued assembly being characterised in that the adhesive comprises particles visible by high-frequency electromagnetic imaging making it possible to determine a value of at least one parameter representing a mechanical alteration of the adhesive when the glued assembly has been thermally excited.

9. The glued assembly according to claim 8, wherein the adhesive comprises a support comprising said particles.

10. The glued assembly according to claim 9, comprising a reference grid forming a fixed reference frame for measuring a movement of the particles.

11. The glued assembly according to claim 10, wherein the reference grid is deposited on at least one of said substrates constituting the glued assembly.

12. The glued assembly according to claim 10, wherein the reference grid is said support comprising said particles, said support being embedded in the adhesive.

13. The glued assembly according to claim 8, wherein said particles are metal particles.

14. The glued assembly according to claim 8, wherein said particles are magnetic particles.

15. A device for generating a map representing mechanically altered zones of a glued assembly consisting of an adhesive comprising particles visible by high-frequency electromagnetic imaging placed between a first substrate and a second substrate, at least one of said substrates consisting of a composite material, said device comprising means for:
determining, from a first image obtained by high-frequency electromagnetic imaging, first positions of said particles in the glued assembly,
determining, from a second image obtained by high-frequency electromagnetic imaging, second positions of said particles in the glued assembly following the application, to said glued assembly, of a local thermal excitation,
generating said map representing mechanically altered zones by associating, with at least one zone of the glued assembly, a value of at least one parameter representing a mechanical alteration of the adhesive, said value of said at least one parameter representing a mechanical alteration of the adhesive and said corresponding glued assembly zone being determined according to said first positions and said second positions of said excitable particles and reference values.

16. A system comprising a device according to claim 15 and a module for moving the device on the glued assembly in order to sweep the whole of the glued assembly.

17. A non-transitory computer-readable medium comprising program code instructions for implementing a method for generating a map representing mechanically altered zones of a so-called glued assembly consisting of an adhesive comprising particles visible by high-frequency electromagnetic imaging, said adhesive being placed between a first substrate and a second substrate, at least one of said substrates consisting of a composite material, said method comprising the following steps:
obtaining, by high-frequency electromagnetic imaging, first positions of said particles in the glued assembly,
local thermal excitation of said glued assembly,
obtaining, by high-frequency electromagnetic imaging, second positions of said particles in the glued assembly,
generating said map representing mechanically altered zones by associating, with at least one glued assembly zone, a value of at least one parameter representing a mechanical alteration of the adhesive, said value of said at least one parameter representing a mechanical alteration of the adhesive and said corresponding glued assembly zone being determined according to said first positions and said second positions of said particles and at least one reference value of the movement of a particle during thermal excitation, when said program code instructions are executed by a processor.
